(19) United States
(12) Patent Application Publication
(10) Pub. No.: US 2022/0345981 A1
(43) Pub. Date: Oct. 27, 2022

(54) Method and Apparatus for Forwarding Data Among Network Nodes in Maritime Network

(71) Applicant: Telefonaktiebolaget LM Ericsson (publ), Stockholm (SE)

(72) Inventors: Yin Liu, Beijing (CN); Jinhua Liu, Beijing (CN); Yanping Dang, Beijing (CN)

(21) Appl. No.: 17/635,614

(22) PCT Filed: Aug. 20, 2019
(86) PCT No.: PCT/CN2019/101492

§ 371 Date: Feb. 15, 2022

(51) Int. Cl. H04W 40/22; H04W 74/08; H04W 76/15; H04W 8/04

(52) U.S. Cl. CPC H04W 40/22; H04W 74/0833; H04W 76/15; H04W 8/04; H04W 92/20

(57) ABSTRACT

Embodiments of the present disclosure provide methods and apparatuses for forwarding data among network nodes in maritime network. A method in a relay terminal device comprises: setting up a first radio connection with a first network node; setting up a second radio connection with a second network node; and notifying the first network node and the second network node that the relay terminal device has network node capability to relay data between the first network node and the second network node.

### TECHNICAL FIELD

The non-limiting and exemplary embodiments of the present disclosure generally relate to the technical field of wireless communications for maritime, and specifically to method and apparatus for forwarding data among network nodes in maritime network.

### BACKGROUND

This section introduces aspects that may facilitate a better understanding of the disclosure. Accordingly, the statements of this section are to be read in this light and are not to be understood as admissions about what is in the prior art or what is not in the prior art.

Traditionally, maritime ships communicate with remote communication devices via terrestrial network when ships are in coverage of terrestrial network, or via satellite networks when the maritime ships are out of reach of the terrestrial network (or in other special conditions). For instance, when out of range of the terrestrial network, machine-to-machine (“M2M”) devices on a maritime ship will connect to a base station on the maritime ship, which in turn is connected via a satellite network to a core network somewhere on land. The connection decision is based on the ship's proximity to the terrestrial network.

The satellite network cannot provide high speed services, like file transfer or video. The satellite can only provide basic communication services. Moreover, satellite coverage is not one hundred percent of the earth and satellite signals may be blocked by cloud or structures on board. In addition, the cost for satellite services is relatively high.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The maritime ship can take advantage of other maritime ships in close proximity to create opportunities for more cost effective and efficient communication therebetween and, ultimately, to the terrestrial networks. Additionally, the present invention does not have to take into account national jurisdictions with respect to the location of the maritime ships, and associated potential ad hoc networks, to send and receive information both legally and efficiently.

Maritime network is a network that can be set up by ships themselves. FIG. 1 shows a schematic maritime network connecting to the terrestrial LTE (Long Time Evolution) network. The maritime network consists of multiple base stations each located in a ship. The base stations connect to each other to form a backhaul link to the terrestrial LTE base station on land. On each ship, there is a base station to provide services to local terminal device(s) on the ship and/or to provide services to another base station on another ship as a parent node in the backhaul link. These different services have different requirements and can be spatially multiplexed to reduce interference therebetween. On each ship, there is also a local core network to assist the base station on board to provide local services. In FIG. 1, LTE is only an example to demonstrate mobile communication.

In the current existing commercial 3GPP (3rd Generation Partnership Project) networks, the backhauling technology was discussed in LTE wherein it is referred to as relay and in NR wherein it is referred to as Integrated Access and Backhaul (IAB).

For relay in LTE, a relay base station can setup radio connection to the donor base station via an enhanced radio interface for relay and the donor base station can schedule the relay base station for UL (uplink)/DL (downlink) data transmissions in the backhaul link. Only single relay hop is supported. Such single hop relay network is not enough for maritime networks where backhaul with many hops is needed.

For IAB networks in NR, the child IAB node and UEs (User Equipment) can share the same integrated access backhaul radio interface. An IAB node owns BS (base station) functionality (i.e. Distributed Unit, DU) and terminal functionality (i.e. Mobile-Termination MT), wherein the DU acts as a BS and MT is used to setup backhaul link to the parent IAB node. According to the 3GPP agreements, IAB network uses CU(Centralized Unit)-DU split structure and the DUs of IAB nodes in an IAB path is controlled by the same CU. The CU is usually located in the donor IAB node and the donor IAB node is the BS with wired backhaul. This structure is supported for NR network. Though 3GPP does not restrict the number of hops, it could be difficult to use such network due to round trip delay of the signaling procedure between the CU and the UEs served by BSs in the ships.

To overcome or mitigate at least one of the above mentioned problems or other problems or provide a useful solution, embodiments of the present disclosure propose a method and apparatus for forwarding data among network nodes in maritime network. Some embodiments provide a solution for a first network node in a first ship to identify a first relay terminal device in the first ship and to use the first relay terminal device to connect to a second network node on another ship to set up a backhaul link so as to form a maritime network which eventually connects to the terrestrial network on land. Some embodiments provide a solution for the first relay terminal device to relay data between the first network node and the second network node. The present invention has good flexibility, low complexity and low cost.

In a first aspect of the disclosure, there is provided a method in a relay terminal device. The method comprises setting up a first radio connection with a first network node; setting up a second radio connection with a second network node; and notifying the first network node and the second network node that the relay terminal device has capability to relay data between the first network node and the second network node.

In an embodiment, the setting up a first radio connection with a first network node comprises: registering in a first Home Subscriber Server, HSS associated with the first network node; initiating a first Physical Random Access Channel, PRACH, procedure to the first network node.

In an embodiment, the setting up a second radio connection with a second network node comprises: registering in a second HSS associated with the second network node; initiating a second PRACH procedure to the second network node.

In an embodiment, the Public Land Mobile Network, PLMN, identification, ID associated with the first network node and the PLMN ID associated with the second network node are same.

In an embodiment, the notifying is performed during or after the PRACH procedure or during registration or session setup procedure.

In an embodiment, the notifying is performed via an identification number, a random access resource, a Physical Random Access Channel, PRACH configuration, a random access cause message, an Radio Resource Control, RRC message, a user equipment category, or a Non-Access Stratum, NAS signaling.

In an embodiment, the method further comprises receiving uplink data or X2/Xn message from the first network node; forwarding the uplink data or X2/Xn message to the second network node.

In an embodiment, the method further comprises receiving downlink data or X2/Xn message from the second network node; forwarding the downlink data or X2/Xn message to the first network node.

In an embodiment, the method further comprises after setting up the first radio connection, detecting a second cell associated with the second network node; reporting cell information of the second cell to the first network node; receiving a request to set up the second radio connection from the first network node.

In an embodiment, the cell information comprises distance from the first network node to the terrestrial network, cell identification of the second cell and radio measurements on the second cell.

In an embodiment, the second network node connects to terrestrial communication network directly or indirectly.

In an embodiment, the first network node and the second network node are each a base station with routing capability.

In an embodiment, the first network node and the second network node are each a base station connecting to a local core network with routing capability.

In an embodiment, the first network node and the relay terminal device are located in a same ship and the second network node is located in another ship.

In a second aspect of the disclosure, there is provided a method in a first network node in the first ship. The method comprises: setting up a first radio connection with a relay terminal device; and receiving a notification from the relay terminal device that the relay terminal device has capability to relay data between the first network node and a second network node.

In an embodiment, the Public Land Mobile Network, PLMN, identification, ID associated with the first network node and the PLMN ID associated with the second network node are same.

In an embodiment, the notification is received during or after a Physical Random Access Channel, PRACH procedure or during registration or session setup procedure.

In an embodiment, the notification is received via an identification number, a random access resource, a Physical Random Access Channel, PRACH configuration, a random access cause message, an Radio Resource Control, RRC message, a user equipment category, or a Non-Access Stratum, NAS signaling.

In an embodiment, the method further comprises sending uplink data or X2/Xn message to the second network node via the relay terminal device.

In an embodiment, the method further comprises receiving downlink data or X2/Xn message from the second network node via the relay terminal device.

In an embodiment, the method further comprises receiving a report on cell information of a second cell associated with the second network node from the relay terminal device; sending a request to set up a second radio connection with the second network node to the relay terminal device.

In an embodiment, the cell information comprises distance from the first network node to the terrestrial network, cell identification of the second cell and radio measurements on the second cell.

In an embodiment, the second network node connects to terrestrial communication network directly or indirectly.

In an embodiment, the first network node and the second network node are each a base station with routing capability.

In an embodiment, the first network node and the second network node are each a base station connecting to a local core network with routing capability.

In an embodiment, the first network node and the relay terminal device are located in a same ship and the second network node is located in another ship.

In another aspect of the disclosure, there is provided a relay terminal device. The relay terminal device comprises a transceiver; a processor; and a memory coupled to the processor, said memory containing instructions executable by said processor, whereby said relay terminal device is operative to set up a first radio connection with a first network node; set up a second radio connection with a second network node; and notify the first network node and the second network node that the relay terminal device has capability to relay data between the first network node and the second network node.

In another aspect of the disclosure, there is provided a first network node. The first network node comprises a transceiver; a processor; and a memory coupled to the processor, said memory containing instructions executable by said processor, whereby said first network node is operative to set up a first radio connection with a relay terminal device; and receive a notification from the relay terminal device that the relay terminal device has capability to relay data between the first network node and a second network node.

In another aspect of the disclosure, there is provided a computer program product, comprising instructions which, when executed on at least one processor, cause the at least one processor to carry out the method according to any of the above first to second aspects.

In another aspect of the disclosure, there is provided a computer-readable storage medium storing instructions which when executed by at least one processor, cause the at least one processor to carry out the method according to any of the above first to second aspects.

According to another aspect of the disclosure, there is provided a method implemented in a communication system including a host computer, a base station and a terminal device. The method comprises, at the host computer, providing user data. The method further comprises, at the host computer, initiating a transmission carrying the user data to the terminal device via a cellular network comprising the base station. The base station is to carry out the method according to the second aspect.

According to another aspect of the disclosure, there is provided a communication system including a host computer comprising processing circuitry configured to provide user data and a communication interface configured to forward the user data to a cellular network for transmission to a terminal device. The cellular network comprises a base station having a radio interface and processing circuitry. The base station's processing circuitry is configured to carry out the method according to the second aspect.

According to another aspect of the disclosure, there is provided a method implemented in a communication system including a host computer, a base station and a terminal device. The method comprises, at the host computer, providing user data. The method further comprises, at the host computer, initiating a transmission carrying the user data to the terminal device via a cellular network comprising the base station. The terminal device is configured to carry out the method according to the first aspect.

According to another aspect of the disclosure, there is provided a communication system including a host computer comprising processing circuitry configured to provide user data and a communication interface configured to forward user data to a cellular network for transmission to a terminal device. The terminal device comprises a radio interface and processing circuitry. The processing circuitry of the terminal device is configured to carry out the method according to the first aspect.

According to another of the disclosure, there is provided a method implemented in a communication system including a host computer, a base station and a terminal device. The method comprises, at the host computer, receiving user data transmitted to the base station from the terminal device. The terminal device is configured to carry out the method according to the first aspect.

According to another aspect of the disclosure, there is provided a communication system including a host computer comprising a communication interface configured to receive user data originating from a transmission from a terminal device to a base station. The terminal device comprises a radio interface and processing circuitry. The processing circuitry of the terminal device is configured to carry out the method according to the first aspect.

According to another aspect of the disclosure, there is provided a method implemented in a communication system including a host computer, a base station and a terminal device. The method comprises, at the host computer, receiving, from the base station, user data originating from a transmission which the base station has received from the terminal device. The base station is configured to carry out the method according to the second aspect.

According to another aspect of the disclosure, there is provided a communication system including a host computer comprising a communication interface configured to receive user data originating from a transmission from a terminal device to a base station. The base station comprises a radio interface and processing circuitry. The base station's processing circuitry is configured to carry out the method according to the second aspect.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows a schematic maritime network connecting to the terrestrial LTE (Long Time Evolution) network;

FIG. 2 shows a flowchart of a method according to an embodiment of the present disclosure;

FIGS. 3(a) and 3(b) show backhaul link setup based on dual connection according to embodiments of the present disclosure;

FIG. 4 shows protocol structure for data forwarding between two network nodes;

FIG. 5 shows a flowchart of a method according to an embodiment of the present disclosure;

FIG. 6 is a block diagram of a relay terminal device according to embodiments of the present disclosure;

FIG. 7 is a block diagram of a first network node according to embodiments of the present disclosure;

FIG. 8 is a diagram showing a telecommunication network connected via an intermediate network to a host computer in accordance with some embodiments;

FIG. 9 is a diagram showing a host computer communicating via a base station with a user equipment in accordance with some embodiments;

FIG. 10 is a flowchart illustrating a method implemented in a communication system in accordance with some embodiments;

FIG. 11 is a flowchart illustrating a method implemented in a communication system in accordance with some embodiments;

FIG. 12 is a flowchart illustrating a method implemented in a communication system in accordance with some embodiments; and

FIG. 13 is a flowchart illustrating a method implemented in a communication system in accordance with some embodiments.

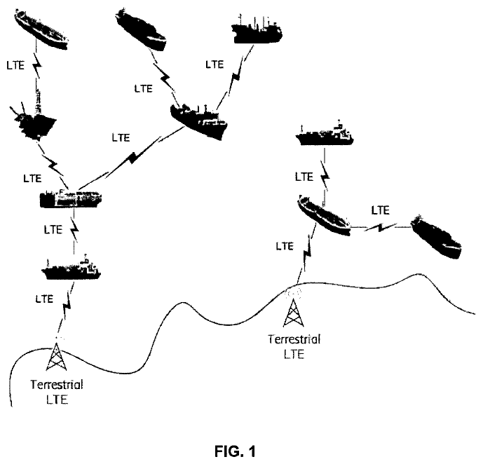

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as the first generation (1G), 2G, 2.5G, 2.75G, 3G, 4G, 4.5G, 5G communication protocols, and/or any other communication standards either currently known or to be developed in the future. In the following description, the terms “network” and “system” can be used interchangeably. Furthermore, the communications between a terminal device and a network node in the communication system may be performed according to any suitable generation communication protocols, including, but not limited to, 1G, 2G, 2.5G, 2.75G, 3G, 4G, 4.5G, 5G communication protocols, and/or any other protocols either currently known or to be developed in the future. In addition, the specific terms used herein do not limit the present disclosure only to the communication system related to the specific terms, which however can be more generally applied to other communication systems.

The term “base station” refers to an access network device in a communication network via which a terminal device accesses to the network and receives services therefrom. For example, the base station (BS) may comprise, but not limited to, an Integrated Access and Backhaul (IAB) node, an access point (AP), a multi-cell/multicast coordination entity (MCE), etc. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

The term “terminal device” refers to any end device that can access a communication network and receive services therefrom. By way of example and not limitation, in the wireless communication network, the terminal device may refer to a mobile terminal, a user equipment (UE), a terminal device, or other suitable devices. The terminal device may be, for example, a Subscriber Station (SS), a Portable Subscriber Station, a Mobile Station (MS), or an Access Terminal (AT). The terminal device may include, but not limited to, a portable computer, an image capture device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a vehicle-mounted wireless device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a UE may represent a terminal device configured for communication in accordance with one or more communication standards for example promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a UE may be designed to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

As yet another example, in an Internet of Things (IOT) scenario, a terminal device may represent a machine or other device that performs monitoring and/or measurements, and transmits the results of such monitoring and/or measurements to another terminal device and/or network equipment. The UE may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a UE may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, a downlink, DL, transmission refers to a transmission from a network device such as base station to a terminal device, and an uplink, UL, transmission refers to a transmission in an opposite direction.

It is noted that the terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

In maritime network, the terminal devices served by the base stations equipped in the ships may be transparent to the anchor base station in terrestrial network. A backhaul path is setup between a base station in a ship to a base station in terrestrial network via interconnections between base stations in different ships. In each ship, there is a private local core network to maintain the local users (terminal devices). In this case, the backhaul path acts as a tunnel to the terrestrial network to forward data for the base stations in ships.

In order to realize data forwarding between the first network node in the first ship and the second network node in the second ship, there is provided a relay terminal device on the first ship. The first base station or a first local core network on the first ship may identify the relay terminal device, differentiate the data transmitted from the relay terminal device between the uplink data from the relay terminal device itself and the relayed downlink data for the terminal devices in the first ship or downstream network node in another ship. The relay terminal device sets up a radio connection with the first base station (and then a first local core network) and a radio connection with the second base station (and then a second local core network). The uplink data from the first base station can be transmitted to the second base station (and eventually to the terrestrial network) via the relay terminal device. The downlink data for the first base station can be transmitted from the second base station to the first base station (and then the local core network on the first ship, and eventually local terminal devices on the first ship) via the relay terminal device.

In this way, a wireless backhaul path to the base station in terrestrial network can be setup for the base stations in different ships and communication information can be relayed to/from terrestrial network. Then, each terminal devices in ships can get access to internet service through their local networks and their ships' communication route.

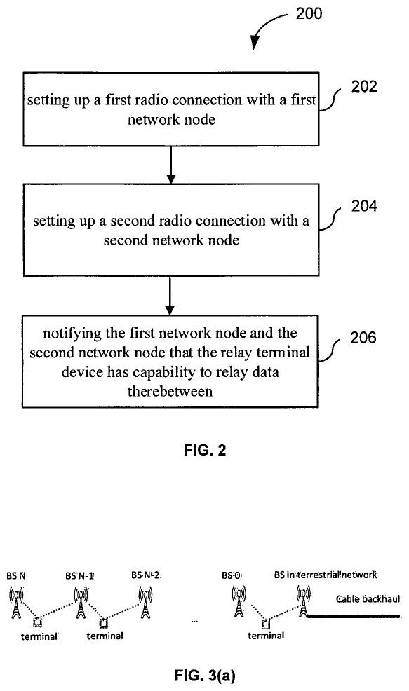

FIG. 2 shows a flowchart of a method according to an embodiment of the present disclosure, which may be performed by an apparatus implemented in or at or communicatively coupled to a relay terminal device or any other entity having similar functionality. As such, the relay terminal device may provide means for accomplishing various parts of the method 200 as well as means for accomplishing other processes in conjunction with other components.

At block 202, the relay terminal device may set up a first radio connection with the first network node in the first ship.

In an embodiment, the relay terminal device may register in a first Home Subscriber Server, HSS associated with the first network node in the first ship. The relay terminal device may initiate a first Physical Random Access Channel, PRACH, procedure to the first network node. The process of setting up radio connection with network node is well known to those skilled in the art. Thus, the more detailed explanation thereof is omitted.

At block 204, the relay terminal device may set up a second radio connection with a second network node in a second ship.

In an embodiment, the relay terminal device may register in a second HSS associated with the second network node. The relay terminal device may initiate a second PRACH procedure to the second network node.

Because the first network node and the second network node connect to the same terrestrial network, the Public Land Mobile Network, PLMN, identification, ID associated with the first network node and the PLMN ID associated with the second network node are same.

At block 206, the relay terminal device may notify the first network node and the second network node that the relay terminal device has capability to relay data between the first network node and the second network node.

In an embodiment, the relay terminal device may perform the notifying during the PRACH procedure respectively.

In an embodiment, the relay terminal device may perform the notifying after the PRACH procedure respectively.

In an embodiment, the relay terminal device may perform the notifying via an identification number (e.g., EMSI (Encrypted Mobile Subscriber Identity) number) identifying the type of terminal device is relay terminal device, a random access resource (e.g., PRACH preamble, PRACH PRBs (Physical Resource Block) reserved for the relay terminal device), a PRACH configuration preconfigured for the relay terminal device, a random access cause message to indicate the intention of the random access is data forwarding, an Radio Resource Control, RRC message to indicate the intention of the random access is data forwarding, or a user equipment category identifying the relay terminal device.

In an embodiment, after the notification, the first network node and/or the second network node are aware of the relay terminal device and its capability of forwarding data between network nodes.

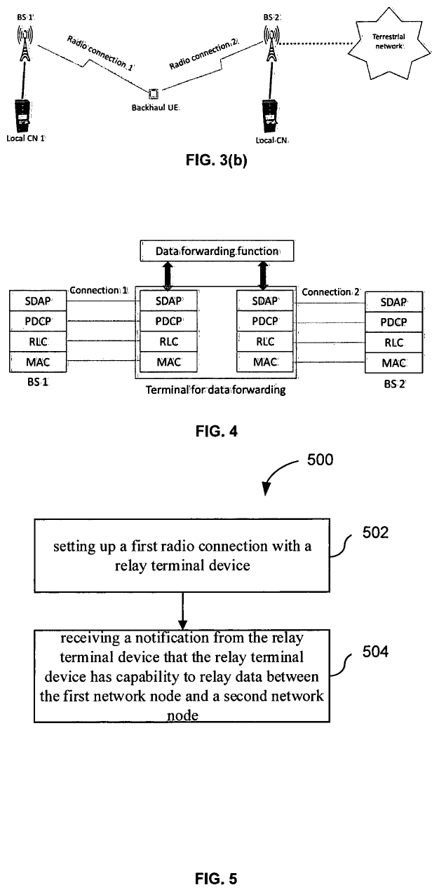

In an embodiment, the data routing function is implemented in the network nodes to handle the data routing on the network side. As shown in FIG. 3(a), the network nodes (“BS-N”, “BS N-1”, “BS N-2”, . . . ) have routing capability and use the relay terminal devices (“terminal”) to forward data therebetween. For data transmission to a network node in the downstream direction, when a network node receives data from an upstream relay terminal device on the same ship, the network node determines if the data should be transmitted to a downstream network node or a local terminal device. If the data is for a downstream network node, the network node may route data to the downstream relay terminal device in another ship without forwarding the data to local core network, i.e. the data routing relies on the routing functionality in the network node. The downstream relay terminal device further transmits the data to a downstream network node. If the data is for a local terminal device, the network node can transmit the data to a local terminal device. For data transmission to a parent network node in the upstream direction, similar procedure is performed.

In this way, data forwarding via core network is avoided. Thus, better latency performance can be achieved.

In an embodiment, the data routing function is implemented in the local core network. In this embodiment, after the notification, the first local core network associated with the first network node in the first ship and/or the second local core network associated with the second network node in the second ship are aware of the relay terminal device and its capability of forwarding data between network nodes. As shown in FIG. 3(b), the local core networks (“local CN1”, “local CN2”, . . . ) have routing capability and use the relay terminal devices (“Backhaul UE”) to forward data therebetween through base stations.

For data transmission to a network node in the downstream direction, when a network node receives data from an upstream relay terminal device in the same ship, the network node may transmit the data to the local core network in the same ship, the local core network packs the data with attached routing information (i.e. the IP address of a child (downstream) relay terminal device in another ship or local terminal devices in the same ship) and routes the data back to the network node. When the network node receives the data from the local core network, it transmits the data to the child relay terminal device or a local terminal device according to the routing information. The child relay terminal device then forwards the data to another network node. For data transmission to a parent network node in the upstream direction, similar procedure is performed. In this way, the network node may not need to know which terminal device is relay terminal device and it is enough that the relay terminal device is only aware by the core network. The information of relay terminal device can be notified to the core network using NAS (Non-Access Stratum) signaling during registration or session setup procedure. This option avoids changes in the network node with respect to routing but has more delay due to data forwarding via core network and such delay occurs in each network node to network node hop.

In an embodiment, after setting up the first radio connection, the relay terminal device may detect a second cell associated with the second network node and report cell information of the second cell to the first network node. The cell information may comprise distance (e.g., number of hops) from the first network node to the terrestrial network, cell identification of the second cell and radio measurements on the second cell. The first network node may evaluate the cell information and send a request to set up the second radio connection to the relay terminal device. Upon receiving the request, the relay terminal device performs process in block 204. In an example, the first network node may configure the relay terminal device to drop the connection to the second network node and setup the radio connection to a third network node for forwarding data to upstream network nodes.

The backhaul path of one hop (i.e. “BS1”—backhaul UE—“BS2”) setup is illustrated in FIG. 3(b). In either ship, there is local core network to provide NAS service for local UEs. A backhaul UE to provide backhauling service for a BS registers in local CN in the same ship. In the left ship, the backhaul UE is used to provide backhauling service for BS 1. The backhaul UE first registers in Local CN 1 in the left ship. After registration, a first radio connection can be setup between BS1 and the backhaul UE, which is referred to as radio connection 1. Then, the backhaul UE can perform neighboring cell search and measurement to determine a candidate parent BS, which is expected to provide backhaul path to the terrestrial network. The UE selects BS2 as its parent BS node on its own or as requested by BS1, wherein BS2 is assumed to be able to connect to the terrestrial network through its parent BS. The backhaul UE then registers in the local CN (i.e. Local CN2) in the same ship of BS2 and a second radio connection is setup between the backhaul UE and BS2. When the first and the second radio connections are setup, BS1 and the backhaul UE can further request for IP address from remote server through the backhaul path to the terrestrial network. When these procedures are finished, the backhaul path to the terrestrial network has been setup for BS 1. The same applies to FIG. 3(a).

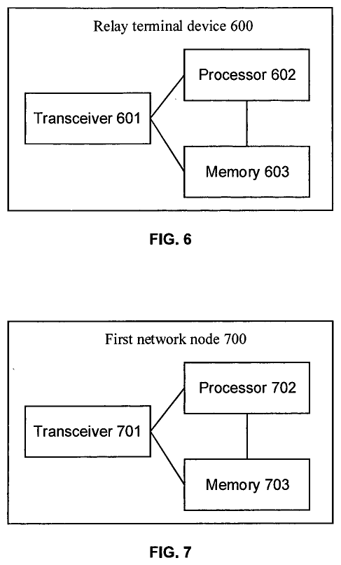

FIG. 4 shows protocol structure for data forwarding between two network nodes. The present invention utilizes the dual connection (DC) function of the terminal device. Compared with traditional dual connection, there is no wired X2 (in LTE) or Xn (in NR) interface between network nodes. The interaction between the network nodes may be avoided at least for the dual connection setup procedure. After the dual connection setup procedure, i.e., after blocks 202 and 204, the relay terminal device may receive X2/Xn message from the first network node and forward the X2/Xn message to the second network node, and vice versa. In FIG. 5, MAC stands for Media Access Control layer, RLC stands for Radio Link Control layer, PDCP stands for Packet Data Convergence Protocol layer, and SDAP stands for Service Data Adapt Protocol layer.

If the relay terminal device receives data from the first network node, the relay terminal device may determine whether the data is for the relay terminal device itself or for the second network node. If the data is for the relay terminal device itself, the relay terminal device may deliver the data to local upper layers. If the data is for the second network node, the relay terminal device may forward the data to the uplink transmission buffer of the connection to the second network node. For the data received from the second network node, the relay terminal device operates similarly.

FIG. 5 shows a flowchart of a method according to an embodiment of the present disclosure, which may be performed by an apparatus implemented in or at or communicatively coupled to a first network node. As such, the first network node may provide means for accomplishing various parts of the method 500 as well as means for accomplishing other processes in conjunction with other components. For some parts which have been described in the above embodiments, detailed description thereof is omitted here for brevity.

At block 502, the first network node may set up a first radio connection with a relay terminal device. This step is routine process well known to those skilled in the art. Details thereof are omitted.

At block 504, the first network node may receive a notification from the relay terminal device that the relay terminal device has capability to relay data between the first network node and a second network node.

In an embodiment, the Public Land Mobile Network, PLMN, identification, ID associated with the first network node and the PLMN ID associated with the second network node are same.

In an embodiment, the notification is received during or after a Physical Random Access Channel, PRACH procedure or during registration or session setup procedure.

In an embodiment, the notification is received via an identification number, a random access resource, a Physical Random Access Channel, PRACH configuration, a random access cause message, an Radio Resource Control, RRC message, a user equipment category, or a Non-Access Stratum, NAS signaling.

In an embodiment, the first network node may send uplink data or X2/Xn message to the second network node via the relay terminal device.

In an embodiment, the first network node may receive downlink data or X2/Xn message from the second network node via the relay terminal device.

In an embodiment, the first network node may receive a report on cell information of a second cell associated with the second network node from the relay terminal device and send a request to set up a second radio connection with the second network node to the relay terminal device.

In an embodiment, the cell information comprises distance from the first network node to a terrestrial network, cell identification of the second cell and radio measurements on the second cell.

In an embodiment, the second network node connects to terrestrial communication network directly or indirectly.

In an embodiment, the first network node and the second network node are each a base station with routing capability.

In an embodiment, the first network node and the second network node are each a base station connecting to a local core network with routing capability.

In an embodiment, the first network node and the relay terminal device are located in a same ship and the second network node is located in another ship.

FIG. 6 is a block diagram of a relay terminal device according to embodiments of the present disclosure.

The relay terminal device 600 includes a transceiver 601, a processor 602 and a memory 603. The memory 603 contains instructions executable by the processor 602 whereby the relay terminal device 600 is operative to perform the actions, e.g., of the procedure described earlier in conjunction with FIG. 2. Particularly, in an embodiment, the memory 603 contains instructions executable by the processor 602 whereby the relay terminal device 600 is operative to: set up a first radio connection with a first network node; set up a second radio connection with a second network node; and notify the first network node and the second network node that the relay terminal device has capability to relay data between the first network node and the second network node.

In some embodiments, the memory 603 may further contain instructions executable by the processor 602 whereby the relay terminal device 600 is operative to perform any of the aforementioned methods, steps, and processes.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 602 causes the relay terminal device 600 to perform the actions, e.g., of the procedure described earlier in conjunction with FIG. 2.

The computer program product may be configured as a computer program code structured in computer program modules. The computer program modules could essentially perform the actions of the flow illustrated in FIG. 2.

FIG. 7 is a block diagram of a first network node according to embodiments of the present disclosure.

The first network node 700 includes a transceiver 701, a processor 702 and a memory 703. The memory 703 contains instructions executable by the processor 702 whereby the first network node 700 is operative to perform the actions, e.g., of the procedure described earlier in conjunction with FIG. 5. Particularly, in an embodiment, the memory 703 contains instructions executable by the processor 702 whereby the first network node 700 is operative to: set up a first radio connection with a relay terminal device; and receive a notification from the relay terminal device that the relay terminal device has capability to relay data between the first network node and a second network node.

In some embodiments, the memory 703 may further contain instructions executable by the processor 702 whereby the first network node 700 is operative to perform any of the aforementioned methods, steps, and processes.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 702 causes the first network node 700 to perform the actions, e.g., of the procedure described earlier in conjunction with FIG. 5.

The computer program product may be configured as a computer program code structured in computer program modules. The computer program modules could essentially perform the actions of the flow illustrated in FIG. 5.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

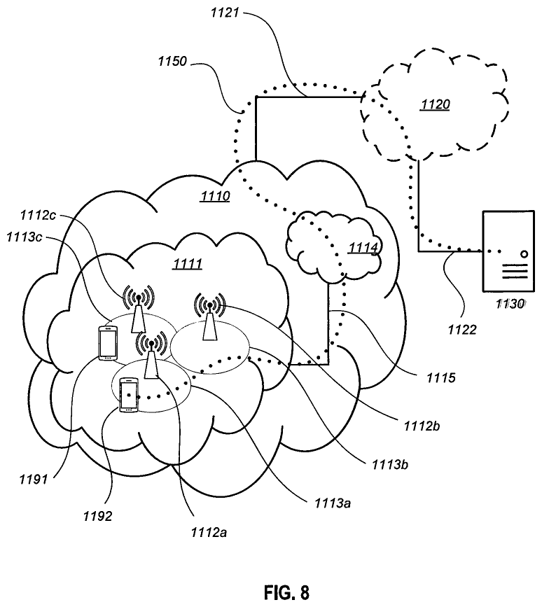

With reference to FIG. 8, in accordance with an embodiment, a communication system includes a telecommunication network 1110, such as a 3GPP-type cellular network, which comprises an access network 1111, such as a radio access network, and a core network 1114. The access network 1111 comprises a plurality of base stations 1112a, 1112b, 1112c, such as NBs, eNBs, gNBs or other types of wireless access points, each defining a corresponding coverage area 1113a, 1113b, 1113c. Each base station 1112a, 1112b, 1112c is connectable to the core network 1114 over a wired or wireless connection 1115. A first user equipment (UE) 1191 located in coverage area 1113c is configured to wirelessly connect to, or be paged by, the corresponding base station 1112c. A second UE 1192 in coverage area 1113a is wirelessly connectable to the corresponding base station 1112a. While a plurality of UEs 1191, 1192 are illustrated in this example, the disclosed embodiments are equally applicable to a situation where a sole UE is in the coverage area or where a sole UE is connecting to the corresponding base station 1112.

The telecommunication network 1110 is itself connected to a host computer 1130, which may be embodied in the hardware and/or software of a standalone server, a cloud-implemented server, a distributed server or as processing resources in a server farm. The host computer 1130 may be under the ownership or control of a service provider, or may be operated by the service provider or on behalf of the service provider. The connections 1121, 1122 between the telecommunication network 1110 and the host computer 1130 may extend directly from the core network 1114 to the host computer 1130 or may go via an optional intermediate network 1120. The intermediate network 1120 may be one of, or a combination of more than one of, a public, private or hosted network; the intermediate network 1120, if any, may be a backbone network or the Internet; in particular, the intermediate network 1120 may comprise two or more sub-networks (not shown).

The communication system of FIG. 8 as a whole enables connectivity between one of the connected UEs 1191, 1192 and the host computer 1130. The connectivity may be described as an over-the-top (OTT) connection 1150. The host computer 1130 and the connected UEs 1191, 1192 are configured to communicate data and/or signaling via the OTT connection 1150, using the access network 1111, the core network 1114, any intermediate network 1120 and possible further infrastructure (not shown) as intermediaries. The OTT connection 1150 may be transparent in the sense that the participating communication devices through which the OTT connection 1150 passes are unaware of routing of uplink and downlink communications. For example, a base station 1112 may not or need not be informed about the past routing of an incoming downlink communication with data originating from a host computer 1130 to be forwarded (e.g., handed over) to a connected UE 1191. Similarly, the base station 1112 need not be aware of the future routing of an outgoing uplink communication originating from the UE 1191 towards the host computer 1130.

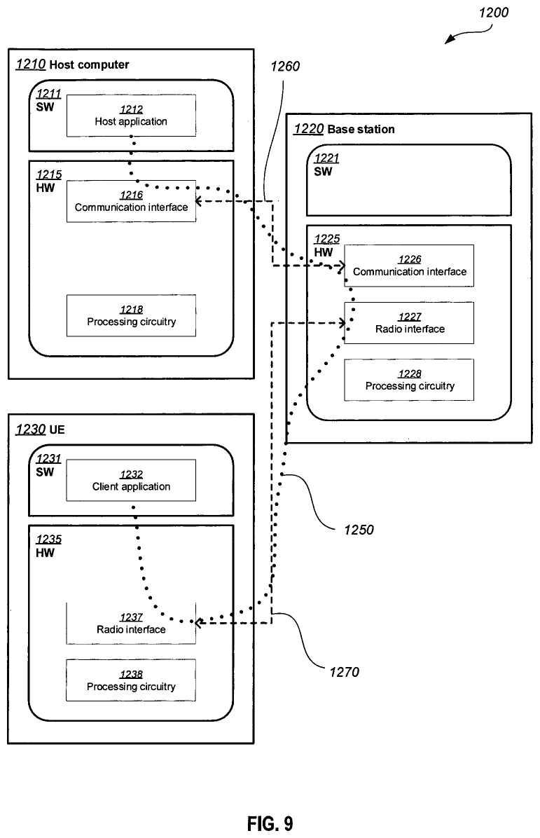

Example implementations, in accordance with an embodiment, of the UE, base station and host computer discussed in the preceding paragraphs will now be described with reference to FIG. 9. In a communication system 1200, a host computer 1210 comprises hardware 1215 including a communication interface 1216 configured to set up and maintain a wired or wireless connection with an interface of a different communication device of the communication system 1200. The host computer 1210 further comprises processing circuitry 1218, which may have storage and/or processing capabilities. In particular, the processing circuitry 1218 may comprise one or more programmable processors, application-specific integrated circuits, field programmable gate arrays or combinations of these (not shown) adapted to execute instructions. The host computer 1210 further comprises software 1211, which is stored in or accessible by the host computer 1210 and executable by the processing circuitry 1218. The software 1211 includes a host application 1212. The host application 1212 may be operable to provide a service to a remote user, such as a UE 1230 connecting via an OTT connection 1250 terminating at the UE 1230 and the host computer 1210. In providing the service to the remote user, the host application 1212 may provide user data which is transmitted using the OTT connection 1250.

The communication system 1200 further includes a base station 1220 provided in a telecommunication system and comprising hardware 1225 enabling it to communicate with the host computer 1210 and with the UE 1230. The hardware 1225 may include a communication interface 1226 for setting up and maintaining a wired or wireless connection with an interface of a different communication device of the communication system 1200, as well as a radio interface 1227 for setting up and maintaining at least a wireless connection 1270 with a UE 1230 located in a coverage area (not shown in FIG. 9) served by the base station 1220. The communication interface 1226 may be configured to facilitate a connection 1250 to the host computer 1210. The connection 1250 may be direct or it may pass through a core network (not shown in FIG. 9) of the telecommunication system and/or through one or more intermediate networks outside the telecommunication system. In the embodiment shown, the hardware 1225 of the base station 1220 further includes processing circuitry 1228, which may comprise one or more programmable processors, application-specific integrated circuits, field programmable gate arrays or combinations of these (not shown) adapted to execute instructions. The base station 1220 further has software 1221 stored internally or accessible via an external connection.

The communication system 1200 further includes the UE 1230 already referred to. Its hardware 1235 may include a radio interface 1237 configured to set up and maintain a wireless connection 1270 with a base station serving a coverage area in which the UE 1230 is currently located. The hardware 1235 of the UE 1230 further includes processing circuitry 1238, which may comprise one or more programmable processors, application-specific integrated circuits, field programmable gate arrays or combinations of these (not shown) adapted to execute instructions. The UE 1230 further comprises software 1231, which is stored in or accessible by the UE 1230 and executable by the processing circuitry 1238. The software 1231 includes a client application 1232. The client application 1232 may be operable to provide a service to a human or non-human user via the UE 1230, with the support of the host computer 1210. In the host computer 1210, an executing host application 1212 may communicate with the executing client application 1232 via the OTT connection 1250 terminating at the UE 1230 and the host computer 1210. In providing the service to the user, the client application 1232 may receive request data from the host application 1212 and provide user data in response to the request data. The OTT connection 1250 may transfer both the request data and the user data. The client application 1232 may interact with the user to generate the user data that it provides.

It is noted that the host computer 1210, base station 1220 and UE 1230 illustrated in FIG. 9 may be identical to the host computer 1130, one of the base stations 1112a, 1112b, 1112c and one of the UEs 1191, 1192 of FIG. 8, respectively. This is to say, the inner workings of these entities may be as shown in FIG. 8 and independently, the surrounding network topology may be that of FIG. 8.

In FIG. 9, the OTT connection 1250 has been drawn abstractly to illustrate the communication between the host computer 1210 and the use equipment 1230 via the base station 1220, without explicit reference to any intermediary devices and the precise routing of messages via these devices. Network infrastructure may determine the routing, which it may be configured to hide from the UE 1230 or from the service provider operating the host computer 1210, or both. While the OTT connection 1250 is active, the network infrastructure may further take decisions by which it dynamically changes the routing (e.g., on the basis of load balancing consideration or reconfiguration of the network).

The wireless connection 1270 between the UE 1230 and the base station 1220 is in accordance with the teachings of the embodiments described throughout this disclosure. One or more of the various embodiments improve the performance of OTT services provided to the UE 1230 using the OTT connection 1250, in which the wireless connection 1270 forms the last segment. More precisely, the teachings of these embodiments may improve the data throughput and thereby provide benefits such as reduced user waiting time.

A measurement procedure may be provided for the purpose of monitoring data rate, latency and other factors on which the one or more embodiments improve. There may further be an optional network functionality for reconfiguring the OTT connection 1250 between the host computer 1210 and UE 1230, in response to variations in the measurement results. The measurement procedure and/or the network functionality for reconfiguring the OTT connection 1250 may be implemented in the software 1211 of the host computer 1210 or in the software 1231 of the UE 1230, or both. In embodiments, sensors (not shown) may be deployed in or in association with communication devices through which the OTT connection 1250 passes; the sensors may participate in the measurement procedure by supplying values of the monitored quantities exemplified above, or supplying values of other physical quantities from which software 1211, 1231 may compute or estimate the monitored quantities. The reconfiguring of the OTT connection 1250 may include message format, retransmission settings, preferred routing etc.; the reconfiguring need not affect the base station 1220, and it may be unknown or imperceptible to the base station 1220. Such procedures and functionalities may be known and practiced in the art. In certain embodiments, measurements may involve proprietary UE signaling facilitating the host computer's 1210 measurements of throughput, propagation times, latency and the like. The measurements may be implemented in that the software 1211, 1231 causes messages to be transmitted, in particular empty or ‘dummy’ messages, using the OTT connection 1250 while it monitors propagation times, errors etc.

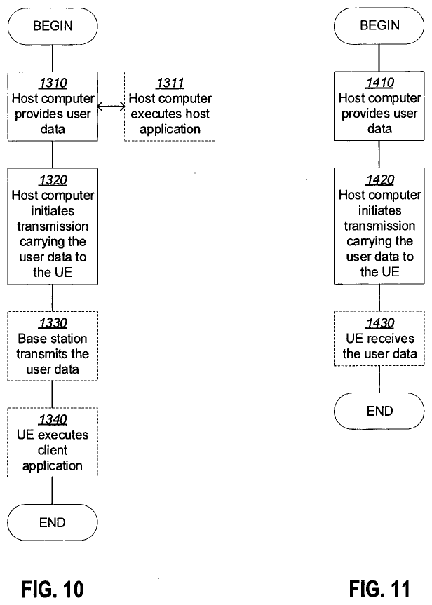

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In a first step 1310 of the method, the host computer provides user data. In an optional substep 1311 of the first step 1310, the host computer provides the user data by executing a host application. In a second step 1320, the host computer initiates a transmission carrying the user data to the UE. In an optional third step 1330, the base station transmits to the UE the user data which was carried in the transmission that the host computer initiated, in accordance with the teachings of the embodiments described throughout this disclosure. In an optional fourth step 1340, the UE executes a client application associated with the host application executed by the host computer.

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In a first step 1410 of the method, the host computer provides user data. In an optional substep (not shown) the host computer provides the user data by executing a host application. In a second step 1420, the host computer initiates a transmission carrying the user data to the UE. The transmission may pass via the base station, in accordance with the teachings of the embodiments described throughout this disclosure. In an optional third step 1430, the UE receives the user data carried in the transmission.

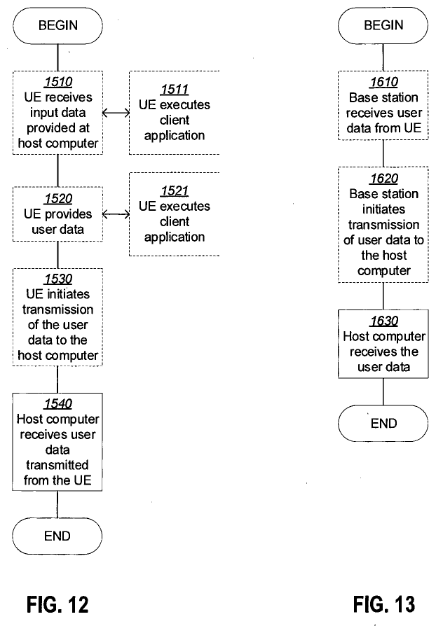

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In an optional first step 1510 of the method, the UE receives input data provided by the host computer. Additionally or alternatively, in an optional second step 1520, the UE provides user data. In an optional substep 1521 of the second step 1520, the UE provides the user data by executing a client application. In a further optional substep 1511 of the first step 1510, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1530, transmission of the user data to the host computer. In a fourth step 1540 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In an optional first step 1610 of the method, in accordance with the teachings of the embodiments described throughout this disclosure, the base station receives user data from the UE. In an optional second step 1620, the base station initiates transmission of the received user data to the host computer. In a third step 1630, the host computer receives the user data carried in the transmission initiated by the base station.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1-32. (canceled)

33. A method in a relay terminal device, the method comprising the relay terminal device:
setting up a first radio connection with a first network node;
setting up a second radio connection with a second network node; and
notifying the first network node and the second network node that the relay terminal device has capability to relay data between the first network node and the second network node.

34. The method of claim 33, wherein the setting up a first radio connection with a first network node comprises:
registering in a first Home Subscriber Server (HSS) associated with the first network node;
initiating a first Physical Random Access Channel (PRACH) procedure to the first network node.

35. The method of claim 34, wherein the setting up a second radio connection with a second network node comprises:
registering in a second HSS associated with the second network node;
initiating a second PRACH procedure to the second network node.

36. The method of claim 35, wherein a Public Land Mobile Network (PLMN) identification (ID) associated with the first network node and the PLMN ID associated with the second network node are same.

37. The method of claim 34, wherein the notifying is performed during or after the PRACH procedure or during registration or session setup procedure.

38. The method of claim 33, wherein the notifying is performed via an identification number, a random access resource, a Physical Random Access Channel (PRACH) configuration, a random access cause message, an Radio Resource Control (RRC) message, a user equipment category, or a Non-Access Stratum (NAS) signaling.

39. The method of claim 33, further comprising:
receiving uplink data or a X2/Xn message from the first network node;
forwarding the uplink data or a X2/Xn message to the second network node.

40. The method of claim 33, further comprising:
receiving downlink data or a X2/Xn message from the second network node;
forwarding the downlink data or a X2/Xn message to the first network node.

41. The method of claim 33, further comprising:
after setting up the first radio connection, detecting a second cell associated with the second network node;
reporting cell information of the second cell to the first network node;
receiving a request to set up the second radio connection from the first network node.

42. The method of claim 41, wherein the cell information comprises distance from the first network node to a terrestrial network, cell identification of the second cell, and radio measurements on the second cell.

43. The method of claim 33, wherein the second network node connects to a terrestrial communication network directly or indirectly.

44. The method of claim 33, wherein the first network node and the second network node are each a base station with routing capability.

45. The method of claim 33, wherein the first network node and the second network node are each a base station connecting to a local core network with routing capability.

46. The method of claim 33, wherein the first network node and the relay terminal device are located in a same ship and the second network node is located in another ship.

47. A method in a first network node, the method comprising the first network node:
setting up a first radio connection with a relay terminal device; and
receiving a notification from the relay terminal device that the relay terminal device has capability to relay data between the first network node and a second network node.

48. The method of claim 47, wherein a Public Land Mobile Network (PLMN) identification (ID) associated with the first network node and the PLMN ID associated with the second network node are same.

49. The method of claim 47, wherein the notification is received during or after a Physical Random Access Channel (PRACH) procedure or during registration or session setup procedure.

50. The method of claim 47, wherein the notification is received via an identification number, a random access resource, a Physical Random Access Channel (PRACH) configuration, a random access cause message, an Radio Resource Control (RRC) message, a user equipment category, or a Non-Access Stratum (NAS) signaling.

51. The method of claim 47, further comprising sending uplink data or a X2/Xn message to the second network node via the relay terminal device.

52. A relay terminal device, comprising:
a transceiver;
processing circuitry;
memory containing instructions executable by the processing circuitry whereby the device is operative to:
set up a first radio connection with a first network node via the transceiver;
set up a second radio connection with a second network node via the transceiver; and
notify, via the transceiver, the first network node and the second network node that the relay terminal device has capability to relay data between the first network node and the second network node.
